(19) United States
(12) Patent Application Publication
(10) Pub. No.: US 2008/0070636 A1
(43) Pub. Date: Mar. 20, 2008

(54) Method and device for dynamic input in handheld terminal

(75) Inventor: Sun Ae Park, Metropolitan City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/798,402

(22) Filed: May 14, 2007

(30) Foreign Application Priority Data
Sep. 20, 2006 (KR) 2006-91190

(51) Int. Cl. H04B 1/38

(52) U.S. Cl. 455/566

(57) ABSTRACT

A method and device for inputting recipient information in a handheld terminal is provided. This method and device facilitates a user's ability to dynamically create and delete an input field for inputting the recipient information. An input field is displayed after creation of a message and the recipient information is input into the displayed input field. An input field is added for entering information about another recipient. The method and device allow dynamic creation or addition, or deletion, of an input field for inputting recipient's phone number or e-mail address, thereby reducing unnecessary consumption of memory space.

### CROSS REFERENCE TO RELATED PATENT APPLICATION

This application claims the benefit under 35 U.S.C. § 119(a) of a Korean Patent Application filed in the Korean Intellectual Property Office on Sep. 20, 2006 and assigned Serial No. 2006-91190, the entire disclosure of which is hereby incorporated by reference.

### BACKGROUND OF THE INVENTION

1. Field of the Invention

The present invention relates to a method and device for dynamic input in a handheld terminal. More particularly, the present invention relates to a method and device for dynamic input that allow dynamic creation of an input field in the handheld terminal.

2. Description of the Related Art

Users of handheld terminals generally use a short message service (SMS) and a multimedia messaging service (MMS) to send messages. After messages are written using the services, a user enters a phone number and electronic mail (e-mail) address of another party into input fields in a menu for inputting a phone number and e-mail address.

The number of input fields is generally limited to 20. However, users of handheld terminals frequently do not use all available input fields. This results in unnecessary consumption of memory space. Further, an embedded system such as a handheld terminal is limited because all input fields cannot be displayed on a single screen. This causes user inconvenience due to movement into subsequent input fields.

Accordingly, there is a need for an improved system and method for dynamic input in a handheld terminal that can reduce unnecessary consumption of memory space and improve display of input fields by creating or deleting input fields for entering a phone number and an e-mail address of a recipient as required by a user.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a method and device for dynamic input in a handheld terminal that can reduce unnecessary consumption of memory space by dynamically creating or deleting input fields for entering a phone number and an e-mail address of a recipient as required by a user.

According to another exemplary embodiment of the present invention, a method and device for dynamic input in a handheld terminal is provided that facilitates the dynamic creation of input fields which will be added as required by the user and can thereby reduce user inconvenience caused by movement into input fields.

Another object of an exemplary embodiment of the present invention is to provide a method and device for dynamic input in a handheld terminal that facilitates simultaneous display of original and new input fields.

According to an exemplary embodiment of the present invention, a method for dynamically inputting recipient information in a handheld terminal is provided to achieve the above objects. An input field is displayed after creation of a message, the recipient information is input into the displayed input field and an input field is added so that information about another recipient may be entered.

The size of a displayed portion of the input field is also increased if the recipient information exceeds the current size of the displayed portion of the input field while the recipient information is input and if a selection is made to delete an input field, the input field is deleted.

In accordance with another exemplary embodiment of the present invention, a method for dynamically inputting recipient information for transmission of a message in a handheld terminal is provided. An input field for inputting the message and the recipient information is displayed. The recipient information is input into the displayed input field and a verification is made as to whether there is further recipient information to be added and a new input field is created if there is further recipient information to be added.

In accordance with another exemplary embodiment of the present invention, there is provided a device for dynamically inputting recipient information in a handheld terminal. This device comprises an input unit for entering recipient information into an input field displayed for transmission of a message and an input field adder for adding a new input field if an additional recipient exists to whom the message will be sent.

Other objects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram illustrating a configuration of a handheld terminal according to an exemplary embodiment of the present invention;

FIG. 2 is a flowchart illustrating a method for dynamic input in a handheld terminal according to an exemplary embodiment of the present invention;

FIG. 3 illustrates representations of screens illustrating an example of creation and deletion of input fields according to an exemplary embodiment of the present invention; and

FIG. 4 illustrates representations of screens illustrating an example of increasing the size of a displayed portion of the input field according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

A mobile communication terminal is herein used as a handheld terminal according to an exemplary embodiment of the present invention. However, it will be obvious to those skilled in the art that the handheld terminal may be any type of information communication device that can add and create input fields or an equivalent thereof, including a digital broadcasting terminal, an International Mobile Telecommunication 2000 (IMT-2000) terminal, a Universal Mobile Telecommunication Service (UMTS) terminal, and a Personal Digital Assistant (PDA).

Recipient information used in an exemplary embodiment of the present invention is equivalent to a recipient's phone number and e-mail address.

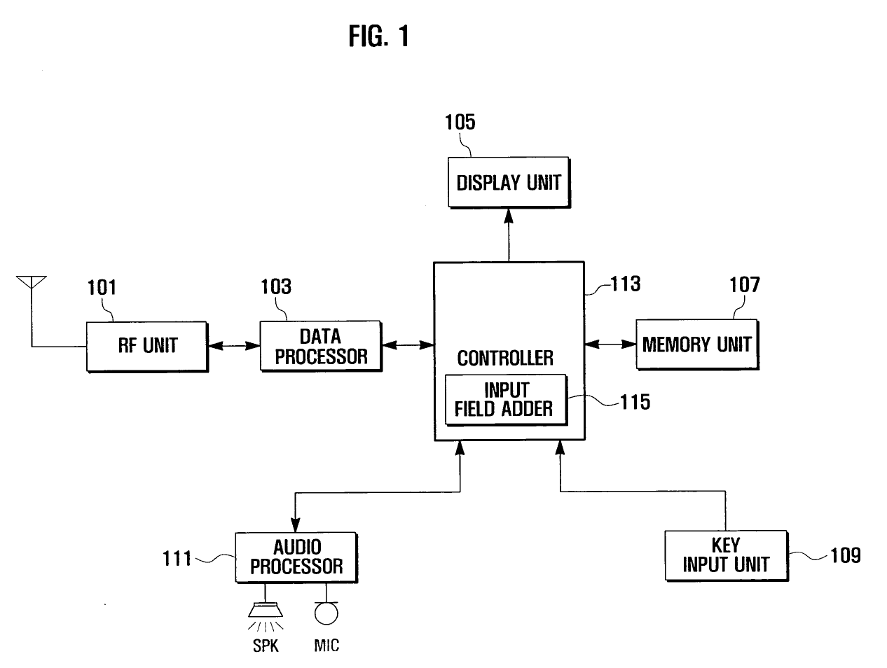

FIG. 1 is a block diagram illustrating a configuration of a handheld terminal according to an exemplary embodiment of the present invention.

Referring to FIG. 1, the handheld terminal includes a radio frequency (RF) unit 101, a data processor 103, a display unit 105, a memory unit 107, a key input unit 109, an audio processor 111, and a controller 113 with an input field adder 115.

The RF unit 101 performs wireless communications of the handheld terminal. The RF unit 101 includes an RF transmitter that up-converts the frequency of a signal being transmitted and amplifies the signal and an RF receiver that low-noise amplifies a received signal and down-converts its frequency.

The data processor 103 processes audio data received from the audio processor 111 or numeric/character data input by a user through the key input unit 109. The data processor 103 may include a transmitter that encodes and modulates a signal for transmission through the RF unit 101 and a receiver that demodulates and decodes a signal received through the RF unit 101. Thus, the data processor 103 can include a modulator/demodulator (modem) and a coder/decoder (codec). The codec includes a data codec for processing incoming data such as packet data and an audio codec for processing audio signals such as voice signals.

The audio processor 111 outputs an audio signal received from the data processor 103 through a speaker SPK, and outputs an audio signal such as voice input through a microphone MIC to the data processor 103.

The key input unit 109 includes multiple numeric and character keys for user input of numeric and character information and function keys for setting various functions. The key input unit 109 receives an input signal for setup or control of the handheld terminal from the user and outputs the input signal to the controller 113. The key input unit 109 also uses keys to input recipient information.

The controller 113 performs the overall control operation of the handheld terminal. The controller 113 is connected to the memory unit 107, display unit 105, data processor 103, and key input unit 109 and includes the input field adder 115. The controller 113 controls the operations of inputting recipient information into an input field and adding and deleting an input field. The input field adder 115 senses the addition of an input field to add to the existing input field.

The memory unit 107 includes a program memory for storing programs for controlling the operation of the handheld terminal and a data memory for temporarily storing data generated while executing the programs. The program memory in the memory unit 107 stores the overall program necessary to create and transmit a message. The data memory stores recipient information entered into an input field. The display unit 105 displays recipient information entered by the user as well as various menus of the handheld terminal. The display unit 105 may be a liquid crystal display (LCD). According to an exemplary implementation, the display unit 105 may include an LCD controller, a memory for storing image data, and an LCD display element.

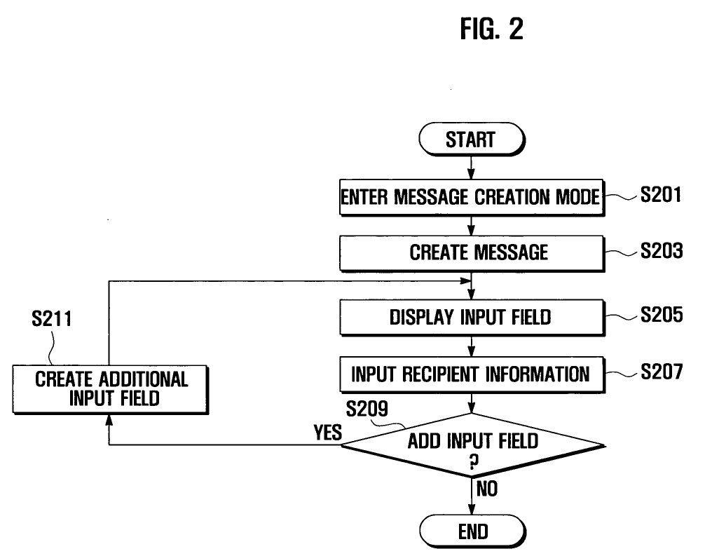

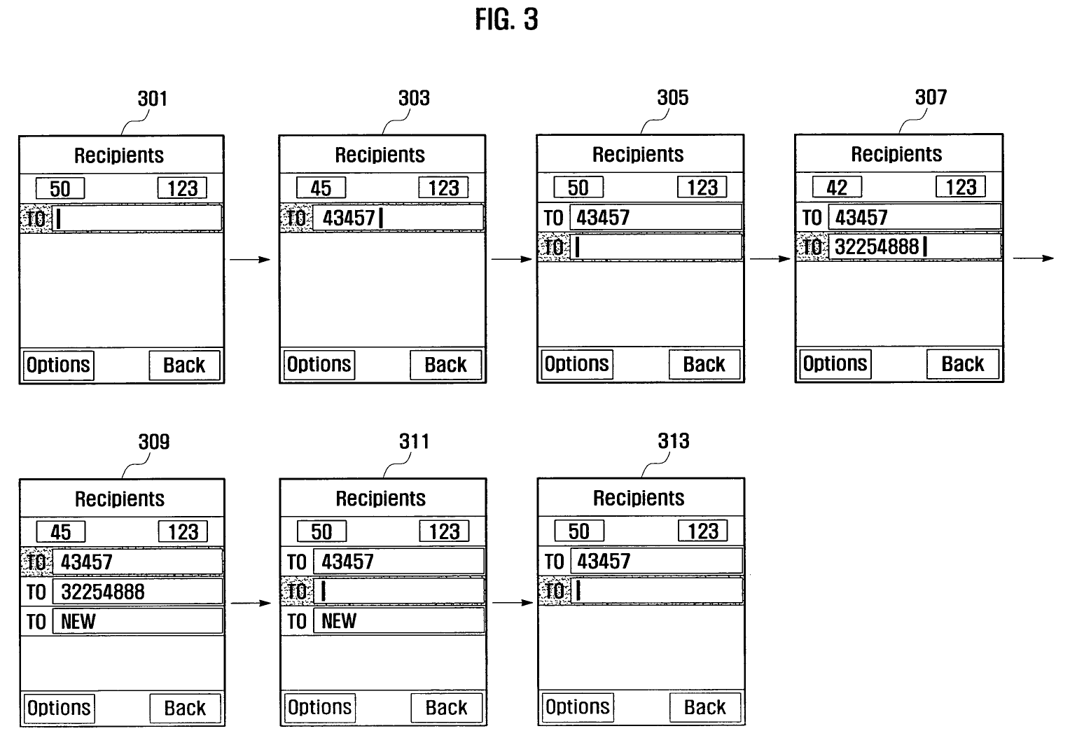

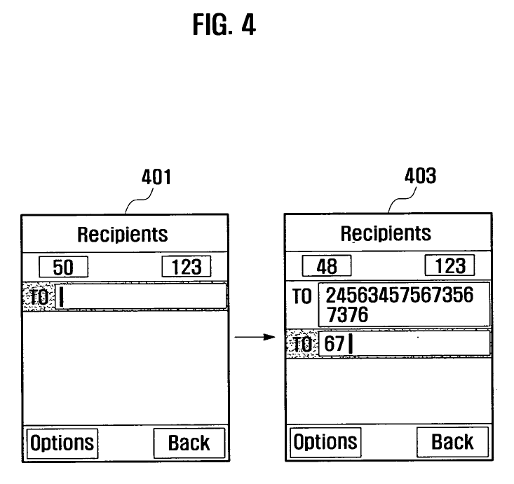

FIG. 2 is a flowchart illustrating a method for dynamic input in a handheld terminal according to an exemplary embodiment of the present invention. FIG. 3 illustrates representations of screens illustrating an example of creation and deletion of input fields according to an exemplary embodiment of the present invention. FIG. 4 illustrates representations of screens illustrating an example of increasing the size of a displayed portion of the input field according to an exemplary embodiment of the present invention.

Referring to FIGS. 2 through 4, the controller 113 operates such that the handheld terminal enters a message creation mode (S201). The user creates a message to be transmitted to a recipient (S203) and may write a message using Short Message Service (SMS) or Multimedia Messaging Service (MMS) methods. For example, the user may create a message saying “We would like to inform you that all members should participate in the 17th meeting at the club room on June 25” using SMS or MMS. The message may be a private message or a public message that can be simultaneously sent to multiple recipients.

After creating the message to be transmitted to the recipient in the message creation mode, the controller 113 controls the display unit 105 to display an input field for entering information about the recipient to whom the message will be sent (hereinafter “recipient information”)(S205), as illustrated in screens 301 and 401 of FIGS. 3 and 4. When previously input recipient information exists, the display unit 105 also displays an input field in which the stored recipient information is contained and a new recipient information is to be added. The displayed numeral “50” shown in screens 301 and 401 represents the total quantity of characters or digits that can currently be entered into the input field. While the examples in FIGS. 3 and 4 illustrate the total quantity of characters or digits as 50, the total quantity may be greater than or less than 50. The total quantity decreases by 1 for each character or digit added. The displayed numeral “123” is a mode type indicator for indicating the current input mode of the input field. In the example, “123” is a digit mode. “123” is presented as an example.

The input mode can be changed from the digit mode into a character mode for input of characters. For example, if a recipient's phone number is a 10-digit number such as “0112223333”, after input in the digit mode, the numeral “50” would decrease by 10 and change into “40”. If a recipient's e-mail address is input, the numeral “50” decreases by the quantity of characters in the e-mail address.

The recipient information is input by the user through the key input unit 109, and the controller 113 processes the recipient information (S207). If the recipient information exceeds the current size of a displayed portion of the input field, the size of the displayed portion of the input field is increased as illustrated in screen 403 of FIG. 4. Conversely, the input field size may not be required to increase as illustrated in screen 303 of FIG. 3. For example, if recipient information in an input field is “245634575673567376” as illustrated in screen 403 of FIG. 4, the size of the displayed portion of the input field is increased. The size may increase to two rows, but the length of the recipient information remains limited to 50 characters/digits as described above.

The controller 113 determines whether an additional recipient exists to whom the user wishes to send the message during input of the recipient information (S209). If an additional recipient exists, the input field adder 115 of the controller 113 creates the input field to be added (S211), and the process returns to step S205 for display of the additional input field so that the user can enter information about another recipient. For example, if the user intends to transmit a message saying “We would like to inform you that all members should participate in the 17th meeting at the club room on June 25” to multiple recipients, the input field adder 115 adds input fields. No additional new input fields are added by the input field adder 115 once the input of recipient information has been completed.

The additional input field is displayed on the display unit 105, as illustrated in screen 305 of FIG. 3. According to an exemplary implementation, previously input recipient information is stored in the memory unit 107. The input field is added when a downward arrow key is pressed by the user. Screen 307 of FIG. 3 illustrates an example of a screen on which a recipient's phone number is entered into the input field added upon the user's request.

If the user ceases to add an input field because no additional recipient exists at step S209, the process ends.

Screen 309 of FIG. 3 illustrates an example of the creation of a new input field for subsequent input after completing input into a current input field, and movement of a cursor to an existing input field.

Screen 311 of FIG. 3 illustrates an example of deleting recipient information from an input field.

Screen 313 of FIG. 3 illustrates an example of deleting an input field having no recipient information upon pressing a downward arrow key after the recipient information has been deleted, as illustrated in screen 311. Screen 313 contains a reduced number of input fields compared to screen 311.

A method and device for dynamic input in a handheld terminal, according to an exemplary embodiment of the present invention, allow dynamic creation, addition or deletion of an input field for entering recipient information according to a user's requirements, thus reducing unnecessary consumption of memory space. Exemplary embodiments of the present invention also eliminate user inconvenience caused by movement into an input field for inputting additional recipient information.

While the present invention has been particularly shown and described with reference to certain exemplary embodiments thereof, it will be understood by those of ordinary skill in the art that various changes and modifications in form and details may be made without departing from the spirit and scope of the present invention as defined by the following claims and their equivalents.

What is claimed is:

1. A method for dynamically inputting recipient information in a handheld terminal, comprising:
displaying an input field after creation of a message;
inputting the recipient information into the displayed input field; and
adding an input field for entering information about another recipient.

2. The method of claim 1, further comprising increasing the size of a displayed portion of the input field if the recipient information exceeds a current size of the displayed portion of the input field while inputting the recipient information.

3. The method of claim 1, wherein the recipient information comprises the recipient's phone number and electronic mail address.

4. The method of claim 1, further comprising storing the recipient information after entering the recipient information into the input field.

5. The method of claim 1, further comprising deleting the input field if a selection is made to delete an input field.

6. A method for dynamically inputting recipient information for transmission of a message in a handheld terminal, comprising:
displaying an input field for inputting the message and the recipient information;
inputting the recipient information into the displayed input field and verifying whether additional recipient information is to be added; and
creating a new input field if further recipient information is to be added.

7. The method of claim 6, wherein the message is created via at least one of a Short Message Service (SMS) and a Multimedia Messaging Service (MMS).

8. The method of claim 6, wherein the recipient information comprises the recipient's phone number and electronic mail address.

9. The method of claim 6, further comprising deleting the input field if a selection is made to delete an input field after completing the input of the recipient information.

10. The method of claim 6, further comprising increasing the size of a displayed portion of the input field if the recipient information exceeds the current size of the displayed portion of the input field while inputting the recipient information.

11. A device for dynamically inputting recipient information in a handheld terminal, comprising:
an input unit for entering recipient information into an input field displayed for transmission of a message; and
an input field adder for generating a new input field if there is another recipient to receive the message.

12. The method of claim 1, wherein a displayed numeral may be entered into the input field.

13. The method of claim 12, wherein the displayed numeral comprises at least one of n characters and n digits.

14. The method of claim 1, further comprising indicating a current input mode of the input field comprising one of a digit mode and a character mode.

15. The method of claim 14, wherein the current input mode is transformed from a digit mode into a character mode for inputting characters.

16. The method of claim 14, wherein the displayed number decreases by the number of digits and characters entered into the input field.

17. The method of claim 16, further comprising indicating the total number of digits and characters that can be entered into the input field in the digit mode and character mode, respectively.

18. The device of claim 11, further comprising a mode type indicator for indicating a current input mode of the input field.
